(19) United States
(12) Patent Application Publication
(10) Pub. No.: US 2025/0016873 A1
(43) Pub. Date: Jan. 9, 2025

(54) APPARATUS FOR WIRELESS CONNECTION RECONFIGURATION IN WIRELESS COMMUNICATION SYSTEM AND METHOD THEREOF

(71) Applicant: Electronics and Telecommunications Research Institute, Daejeon (KR)

(72) Inventors: Kyung Sook KIM, Daejeon (KR); Dae Ik KIM, Daejeon (KR); Hyung-sub KIM, Daejeon (KR); JeeHyeon NA, Daejeon (KR); Hye Kyung JWA, Daejeon (KR)

(21) Appl. No.: 18/766,536

(22) Filed: Jul. 8, 2024

(30) Foreign Application Priority Data
Jul. 6, 2023 (KR) 10-2023-0087890
Jul. 8, 2024 (KR) 10-2024-0089345

(51) Int. Cl. H04W 76/27

(52) U.S. Cl. CPC H04W 76/27

(57) ABSTRACT

A apparatus for wireless connection reconfiguration in a wireless communication system and a method thereof are proposed. The disclosed generally relates to the wireless communication system and, more particularly, to the apparatus for the wireless connection reconfiguration in the wireless communication system and the method thereof. The method for a base station (BS) in the wireless communication system includes a process of transmitting a connection reconfiguration request (RRCReconfiguration) message to a user equipment (UE), a process of reconfiguring the UE on the basis of the connection reconfiguration request message, and a process of completing the reconfiguration of the UE on the basis of a connection reconfiguration complete (RRCReconfigurationComplete) message received from the UE.

### CROSS REFERENCE TO RELATED APPLICATION

The present application claims priority to Korean Patent Application No. 10-2023-0087890, filed on Jul. 6, 2023, and Korean Patent Application No. 10-2024-0089345, filed on Jul. 8, 2024, the entire contents of which are incorporated herein for all purposes by this reference.

### BACKGROUND OF THE INVENTION

### Field of the Invention

The present disclosure generally relates to a wireless communication system and, more particularly, to a apparatus for wireless connection reconfiguration in a wireless communication system and a method thereof.

### Description of the Related Art

In wireless communication systems, it is very important to ensure the efficiency and stability of data transmission. In particular, an radio resource control (RRC) connection reconfiguration procedure used in the wireless communication systems plays an important role in maintaining smooth communication between user equipments and networks through various settings and reconfiguration processes.

In existing wireless communication systems, various problems may occur during the RRC connection reconfiguration procedure. For example, there may exist a mismatch in configuration information between a user equipment (UE) and a base station, so there is a problem in transmitting and receiving data, or communication efficiency may be reduced due to certain settings applied incorrectly. Such problems may lead to data transmission delays, packet loss, and overall poor communication quality.

### SUMMARY OF THE INVENTION

Based on the description as described above, the present disclosure provides a apparatus for wireless connection reconfiguration in a wireless communication system and a method thereof.

In addition, the present disclosure provides the apparatus for establishment and release of discontinuous reception (DRX)-Config in the wireless communication system and the method thereof.

In addition, the present disclosure provides the apparatus for establishment and release of measGapConfig in the wireless communication system and the method thereof.

In addition, the present disclosure provides the apparatus for secondary carrier reconfiguration in the wireless communication system and the method thereof.

According to various exemplary embodiments of the present disclosure, there is provided a method of operating a base station (BS) in a wireless communication system, the method including: a process of transmitting a connection reconfiguration request (RRCReconfiguration) message to a user equipment (UE); a process of reconfiguring the UE on the basis of the connection reconfiguration request message; and a process of completing the reconfiguration of the UE on the basis of a connection reconfiguration complete (RRCReconfigurationComplete) message received from the UE.

According to the various exemplary embodiments of the present disclosure, there is provided a apparatus for a base station (BS) in a wireless communication system, the apparatus including: a transceiver; a first user equipment (UE) reconfiguration unit; a second user equipment (UE) reconfiguration unit; and a control unit operably connected to the transceiver, the first UE reconfiguration unit, and the second UE reconfiguration unit, wherein the control unit may be configured to transmit a connection reconfiguration request (RRCReconfiguration) message to the user equipment (UE), reconfigure the UE on the basis of the connection reconfiguration request message, and complete the reconfiguration of the UE on the basis of a connection reconfiguration complete (RRCReconfigurationComplete) message received from the UE.

According to the various exemplary embodiments of the present disclosure, there is provided a method of operating a UE in a wireless communication system, the method including: a process of receiving a connection reconfiguration request (RRCReconfiguration) message from a base station; a process of reconfiguring the UE on the basis of the connection reconfiguration request message; and a process of transmitting a connection reconfiguration complete (RRCReconfigurationComplete) message to the base station after the connection reconfiguration is completed.

According to the various exemplary embodiments of the present disclosure, there is provided a UE in a wireless communication system, the UE including: a transceiver; a reconfiguration unit; and a control unit operably connected to the transceiver and the reconfiguration unit, wherein the control unit may receive a connection reconfiguration request (RRCReconfiguration) message from a base station, reconfigure the UE on the basis of the connection reconfiguration request message, and transmit a connection reconfiguration complete (RRCReconfigurationComplete) message to the base station after the connection reconfiguration is completed.

The apparatus and the method thereof according to various exemplary embodiments of the present disclosure solve data transmission and reception problems that may occur due to mismatch in UE configuration information between a base station and a UE during the radio resource control (RRC) connection reconfiguration procedure of the UE in a wireless communication system, whereby waste of wireless resources may be prevented from occurring.

The effects of the present disclosure are not limited to the above-mentioned effects, and other different effects that are not mentioned will be clearly understood by those skilled in the art from the following description.

### BRIEF DESCRIPTION OF THE DRAWINGS

FIG. 1A is a view illustrating an RRC connection reconfiguration procedure according to various exemplary embodiments of the present disclosure.

FIG. 1B is a view illustrating an RRC connection reconfiguration procedure including physical downlink data channel establishment according to various exemplary embodiments of the present disclosure.

FIG. 1C is a view illustrating an RRC connection reconfiguration procedure including release of DRX-config according to various exemplary embodiments of the present disclosure.

FIG. 1D is a view illustrating an RRC connection reconfiguration procedure including release of measGapConfig according to various exemplary embodiments of the present disclosure.

FIG. 1E is a view illustrating an RRC connection configuration procedure including secondary carrier reconfiguration according to various exemplary embodiments of the present disclosure.

FIG. 2 is a view illustrating an RRC connection reconfiguration procedure in a wireless communication system according to an exemplary embodiment of the present disclosure.

FIG. 3 is a view illustrating an RRC connection reconfiguration procedure including physical uplink channel establishment according to the exemplary embodiment of the present disclosure.

FIG. 4 is a view exemplifying physical downlink data channel reconfiguration of a second UE reconfiguration function according to the exemplary embodiment of the present disclosure.

FIG. 5 is a view illustrating an RRC connection reconfiguration procedure including release of DRX-Config according to the exemplary embodiment of the present disclosure.

FIG. 6 is a view illustrating an RRC connection reconfiguration procedure including DRX-Config setup according to the exemplary embodiment of the present disclosure.

FIG. 7 is a view illustrating an RRC connection reconfiguration procedure including release of measGapConfig according to the exemplary embodiment of the present disclosure.

FIG. 8 is a view illustrating an RRC connection reconfiguration procedure including measGapConfig setup according to the exemplary embodiment of the present disclosure.

FIG. 9 is a view illustrating an RRC connection reconfiguration procedure including secondary carrier reconfiguration according to the exemplary embodiment of the present disclosure.

FIG. 10 is a view illustrating a configuration diagram of a base station in a wireless communication system according to various exemplary embodiments of the present disclosure.

FIG. 11 is a view illustrating a configuration diagram of a UE in the wireless communication system according to various exemplary embodiments of the present disclosure.

### DETAILED DESCRIPTION OF THE INVENTION

The terms used in the present disclosure are only used to describe specific exemplary embodiments, and may not be intended to limit the scope of other exemplary embodiments. As used herein, the singular forms may include the plural forms as well, unless the context clearly indicates otherwise. The terms including technical and scientific terms used herein have the same meaning as commonly understood by those skilled in the art described in the present disclosure. Among the terms used in the present disclosure, terms defined in a general dictionary may be interpreted as having the same or similar meaning as the meaning in the context of the related art, and are not interpreted in an ideal or excessively formal meaning unless explicitly defined in the present disclosure. In some cases, even the terms defined in the present disclosure may not be interpreted to exclude the exemplary embodiments of the present disclosure.

In various exemplary embodiments of the present disclosure described below, a hardware approach method is described as an example. However, since the various exemplary embodiments of the present disclosure include technology using both hardware and software, the various exemplary embodiments of the present disclosure do not exclude a software-based approach method.

In addition, in the detailed description and claims of the present disclosure, “at least one of A, B, and C” may mean “only A”, “only B”, and “only C”, or may mean “any combination of A, B, and C”. In addition, “at least one of A, B, or C” or “at least one of A, B, and/or C” may mean “at least one of A, B, and C”.

Hereinafter, the present disclosure relates to a apparatus for wireless connection reconfiguration in a wireless communication system and a method thereof. Specifically, the present disclosure describes a technology for preventing waste of wireless resources from occurring by solving data transmission and reception problems that may occur due to mismatch in UE configuration information between a base station and a user equipment (UE) during a radio resource control (RRC) connection reconfiguration procedure of the UE in the wireless communication system.

In the following description, terms referring to signals, terms referring to channels, terms referring to control information, terms referring to network entities, terms referring to components of a apparatus, and the like are illustrated for convenience of the description. Accordingly, the present disclosure is not limited to the terms described below, but other terms having equivalent technical meanings may be used.

In addition, the present disclosure describes various exemplary embodiments by using terms used in some communication standards (e.g., 3rd Generation Partnership Project, 3GPP), but this is only an example for description. Various exemplary embodiments of the present disclosure may be easily modified and applied to other communication systems.

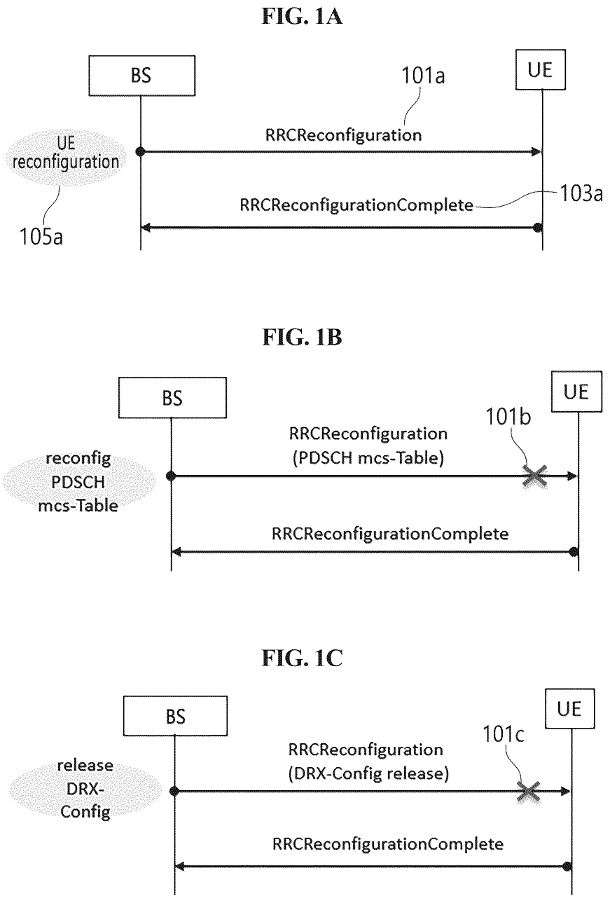

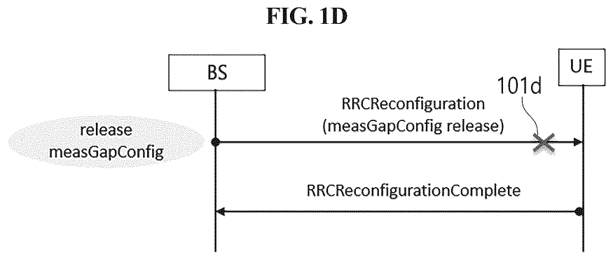

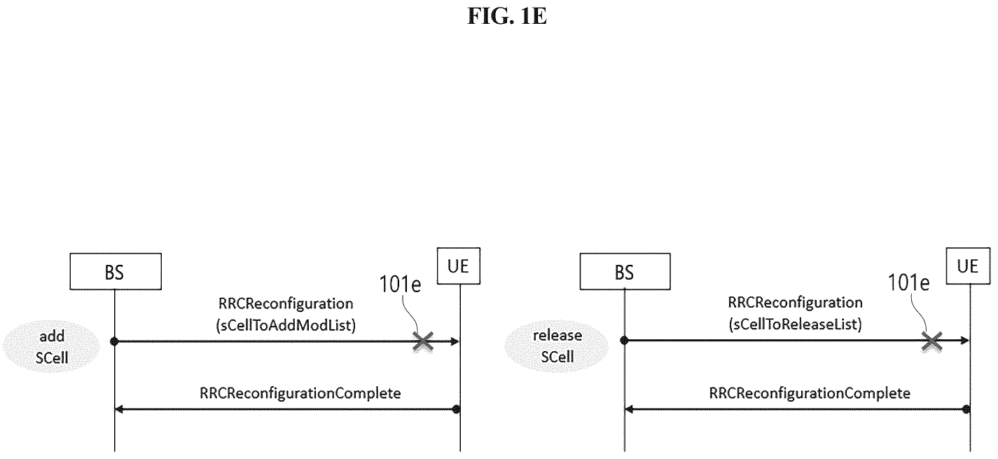

FIG. 1A is a view illustrating an RRC connection reconfiguration procedure according to various exemplary embodiments of the present disclosure. FIGS. 1A to 1E relate to RRC connection reconfiguration procedures that occur after RRC connection establishment of a UE in a wireless communication system, and the RRC connection reconfiguration procedures are defined in 3GPP TS 38.331.

In the RRC reconfiguration procedure of FIG. 1A, a base station may compose an RRCReconfiguration message to transmit this message to the UE in 101a.

The UE may reconfigure RRC connection on the basis of the received RRCReconfiguration message, and may transmit an RRCReconfigurationComplete message in 103a.

In the RRC reconfiguration procedure of FIG. 1A, the base station may reconfigure the UE in 105a on the basis of the RRCReconfiguration message transmitted to the UE.

The base station may perform radio resource allocation on the basis of UE reconfiguration information and receive, in 103a, an RRCReconfigurationComplete message transmitted after completion of RRC connection reconfiguration of the UE.

According to the exemplary embodiment, the RRCReconfiguration message may include physical downlink control channel and downlink data channel reconfiguration. The UE may reconfigure the physical downlink control channel and downlink data channel on the basis of the received RRCReconfiguration message.

FIG. 1B is a view illustrating an RRC connection reconfiguration procedure including physical downlink data channel establishment according to various exemplary embodiments of the present disclosure.

Referring to FIG. 1B, a base station may reconfigure mcs-table settings of a physical downlink data channel on the basis of UE reconfiguration information before RRC connection reconfiguration of the UE is completed.

In a case where an MCS index of PDSCH is assigned on the basis of reconfiguring the mcs-Table settings of the physical downlink data channel based on the reconfiguration information, as size mismatch in a PDSCH transport block (TB) occurs due to mismatch in the mcs-table settings between the base station and the UE, there may occur a problem that the UE is unable to receive the physical downlink data channel transmitted from the base station to the UE, and is unable to receive downlink data including RRCReconfiguration in 101b.

FIG. 1C is a view illustrating an RRC connection reconfiguration procedure including release of DRX-config according to various exemplary embodiments of the present disclosure.

The RRCReconfiguration message may include establishment and release of DRX-Config. As described in Chapter 5.7 of 3GPP TS 38.321, when DRX-Config is released, the UE may receive PDCCH in all slots for which PDCCH monitoring is established, and when DRX-Config is established, the UE may receive PDCCH in a DRX Active Time period defined by the DRX-Config.

Referring to FIG. 1C, in the RRC connection reconfiguration procedure including DRX-Config, in a case of a period when DRX-Config setup or release status between a base station and a UE is a mismatch, there may occur a problem that the UE is unable to receive PDCCH transmitted by the base station, and is unable to receive downlink data including RRCReconfiguration in 101c.

FIG. 1D is a view illustrating an RRC connection reconfiguration procedure including release of measGapConfig according to various exemplary embodiments of the present disclosure.

Referring to FIG. 1D, an RRCReconfiguration message may include the measGapConfig setup and release. As described in Chapter 5.14 of 3GPP TS 38.321, when measGapConfig is established, the UE stops transmitting and receiving wireless signals and data during a measurement gap period in a serving cell within a corresponding frequency range.

Accordingly, in the RRC connection reconfiguration procedure including measGapConfig, in a case of a period when measGapConfig setup or release status between a base station and the UE is a mismatch in 101d, there may occur a problem that the UE is unable to receive downlink data including RRCReconfiguration transmitted by a mobile communication system.

FIG. 1E is a view illustrating an RRC connection configuration procedure including secondary carrier reconfiguration according to various exemplary embodiments of the present disclosure.

Referring to FIG. 1E, an RRCReconfiguration message may include sCellToAddModList and sCellToReleaseList, which reconfigure a secondary carrier.

According to Section 7.3.1.2 of 3GPP TS 38.212 below, a size of a Downlink Assignment Index (DAI) field of downlink control information DCI 1_1 is determined by the number of secondary carrier settings of the UE when pdsch-HARQ-ACK-Codebook=dynamic.

```
Downlink assignment index - number of bits as defined in the following
  - 4 bits if more than one serving cell are configured in the DL and the higher layer parameter
  pdsch-HARQ-ACK-Codebook=dynamic, where the 2 MSB bits are the counter DAI and
  the 2 LSB bits are the total DAI;
  - 2 bits if only one serving cell is configured in the DL and the higher layer parameter pdsch-
  HARQ-ACK-Codebook=dynamic, where the 2 bits are the counter DAI;
- 0 bits otherwise.
```

In a case where a size of DCI transmitted from a base station and a size of DCI that the UE attempts to decode are mismatch, the UE may fail to decode the DCI transmitted from the base station and may not receive the DCI.

Accordingly, in the RRC connection reconfiguration procedure including secondary carrier reconfiguration, in a case where a size mismatch period of downlink control information (DCI) based on the secondary carrier establishment information occurs between the base station and the UE, there may occur a problem that the UE is unable to receive the DCI transmitted by the base station.

As described above, in order to solve the problems occurring in the RRC connection reconfiguration procedure, the method for RRC connection reconfiguration in a wireless communication system and the apparatus thereof are required.

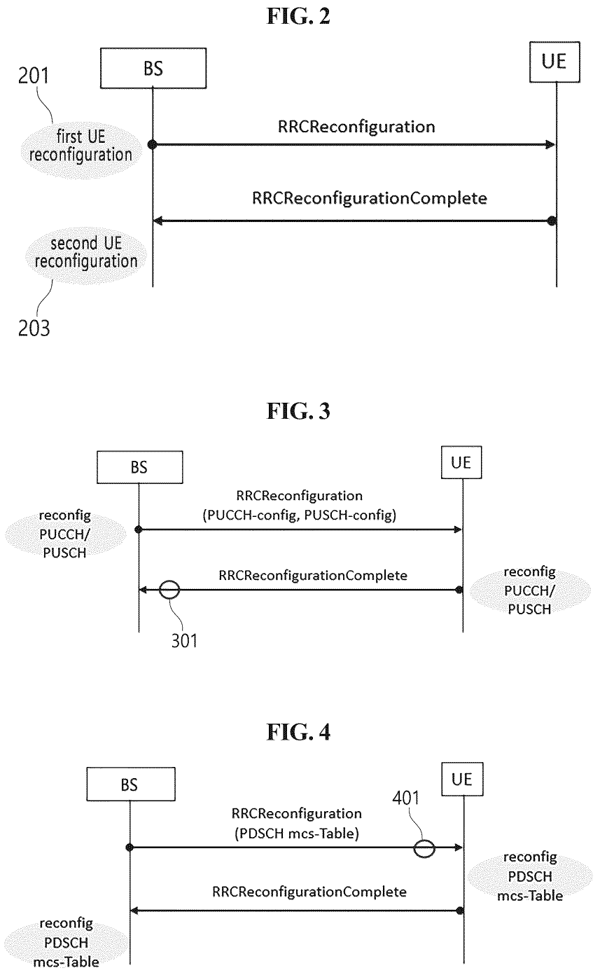

FIG. 2 is a view illustrating an RRC connection reconfiguration procedure in the wireless communication system according to the exemplary embodiment of the present disclosure.

Referring to FIG. 2, a base station may include a first UE reconfiguration function 201 and a second UE reconfiguration function 203. The first UE reconfiguration function 201 may perform a UE reconfiguration function on the basis of an RRCReconfiguration message at a time when the RRCReconfiguration message is composed and transmitted to the UE in the wireless communication system.

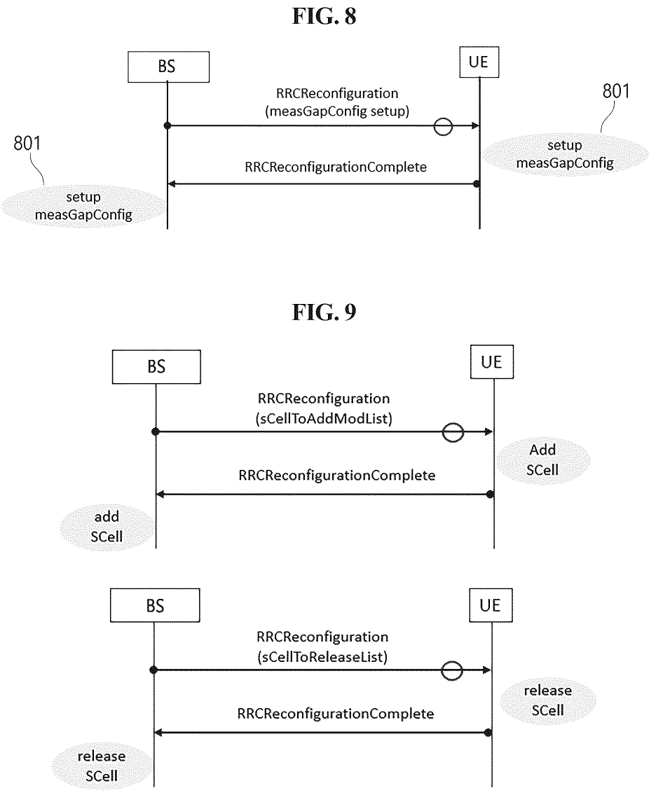

As shown in FIG. 8, the first UE reconfiguration function 201 may include UE-specific physical uplink control channel and uplink data channel reconfiguration on the basis of the RRCReconfiguration message.

FIG. 3 is a view illustrating an RRC connection reconfiguration procedure including physical uplink channel establishment according to the exemplary embodiment of the present disclosure.

Referring to FIG. 3, a base station allocates resources of the physical uplink control channel and uplink data channel on the basis of UE reconfiguration information, whereby the base station is enabled to receive the physical uplink control channel and uplink data channel, which are transmitted after the UE completes RRC connection reconfiguration in 301.

In this way, according to the present disclosure, the first UE reconfiguration function allows the base station to receive an RRCReconfigurationComplete signal message transmitted from the UE.

The second UE reconfiguration function 203 may perform a UE reconfiguration function on the basis of the RRCReconfiguration message after the base station receives the RRCReconfigurationComplete message transmitted by the UE.

The second UE reconfiguration function 203 may include functions performing UE-specific physical downlink control channel and downlink data channel reconfiguration, establishment and release of DRX-Config, establishment and release of measGapConfig, and secondary carrier reconfiguration on the basis of the RRCReconfiguration message.

FIG. 4 is a view exemplifying physical downlink data channel reconfiguration of the second UE reconfiguration function according to the exemplary embodiment of the present disclosure.

Referring to FIG. 4, a base station allocates resources of a physical downlink data channel on the basis of physical downlink data channel configuration information preset at the time of transmitting an RRCReconfiguration message, thereby enabling the UE to receive an RRCReconfiguration message transmitted from the base station in 401.

In addition, the base station reconfigures the physical downlink data channel on the basis of the RRCReconfiguration message after receiving an RRCReconfigurationComplete message transmitted from the UE, thereby matching physical downlink data channel setups of a mobile communication system and the UE after completing RRC reconfiguration in the UE, and allowing the UE to receive the physical downlink data channel transmitted from the base station.

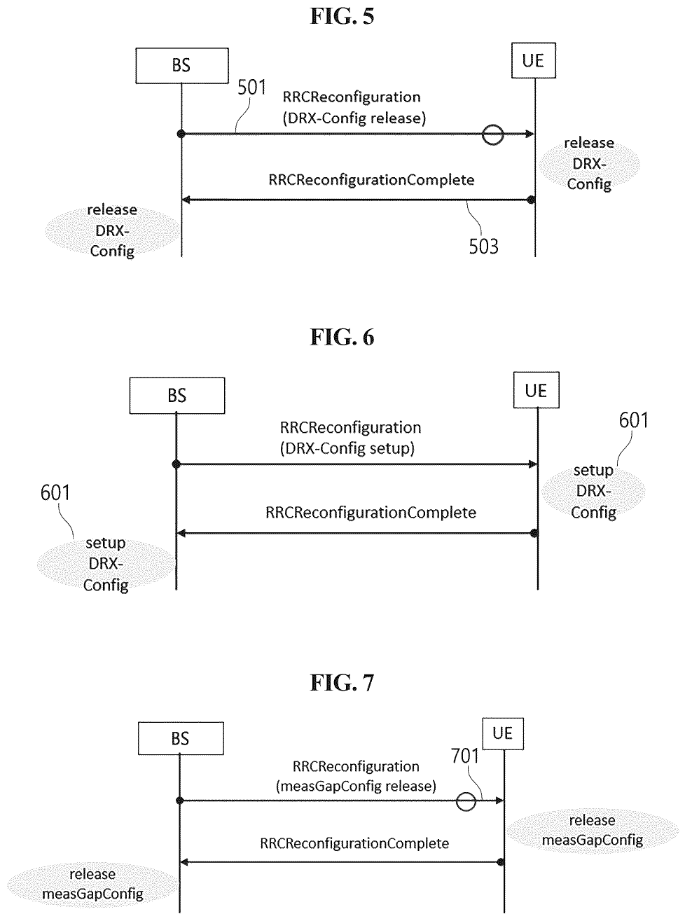

FIG. 5 is a view illustrating an RRC connection reconfiguration procedure including release of DRX-Config according to the exemplary embodiment of the present disclosure. FIG. 5 illustrates the exemplary embodiment of the DRX-Config release of the second UE reconfiguration function.

FIG. 6 is a view illustrating an RRC connection reconfiguration procedure including DRX-Config setup according to the exemplary embodiment of the present disclosure.

Referring to FIG. 5, a base station determines a DRX Active Time period on the basis of the DRX-Config setup preset at the time of transmitting an RRCReconfiguration message, thereby allowing the UE to receive a physical downlink control channel transmitted from the base station to the UE in 501. In this way, according to the second UE reconfiguration function of the present disclosure, the UE is allowed to receive the RRCReconfiguration signal message transmitted from the base station to the UE in 503.

Referring to FIGS. 5 and 6, in 601, after receiving an RRCReconfigurationComplete message transmitted from the UE, the base station performs the DRX-Config release or DRX-Config setup on the basis of the RRCReconfiguration message, thereby matching the DRX-Config setups of the base station and the UE after completing the RRC reconfiguration of the UE according to the second UE reconfiguration function.

FIG. 7 is a view illustrating an RRC connection reconfiguration procedure including measGapConfig release according to an exemplary embodiment of the present disclosure.

FIG. 8 is a view illustrating an RRC connection reconfiguration procedure including measGapConfig setup according to the exemplary embodiment of the present disclosure.

Referring to FIG. 7, a base station determines a measurement gap period on the basis of the measGapConfig setup preset at the time of transmitting an RRCReconfiguration message, thereby allowing the UE to receive a physical downlink control channel and an RRCReconfiguration signal message, which are transmitted from the base station to the UE in 701.

Referring to FIGS. 7 and 8, after receiving an RRCReconfigurationComplete message transmitted from the UE, the base station performs the measGapConfig release or measGapConfig setup on the basis of the RRCReconfiguration message, thereby being able to match the measGapConfig setups of the mobile communication system and the UE after completing the RRC reconfiguration of the UE according to the second UE reconfiguration function in 801.

FIG. 9 is a view illustrating an RRC connection reconfiguration procedure including secondary carrier reconfiguration according to an exemplary embodiment of the present disclosure. FIG. 9 illustrates the exemplary embodiment of the reconfiguration including secondary carrier addition or secondary carrier release of the second UE reconfiguration function.

Referring to FIG. 9, a base station determines a downlink control information (DCI) size on the basis of secondary carrier establishment information preset at the time of transmitting an RRCReconfiguration message, thereby being able to match a size of DCI transmitted by the base station and a size of DCI that the UE attempts to decode.

The UE is enabled to receive a physical downlink control channel transmitted from the base station to the UE. In this way, according to the second UE reconfiguration function, the UE is enabled to receive an RRCReconfiguration signal message transmitted from the base station to the UE.

In addition, referring to FIG. 9, the base station reconfigures a secondary carrier on the basis of the RRCReconfiguration message after receiving the RRCReconfigurationComplete message transmitted from the UE, thereby matching the sizes of the secondary carrier establishment information and downlink control information (DCI) of the base station and the UE after the RRC reconfiguration is completed in the UE, and enabling the UE to receive a physical downlink control channel transmitted from the base station to the UE.

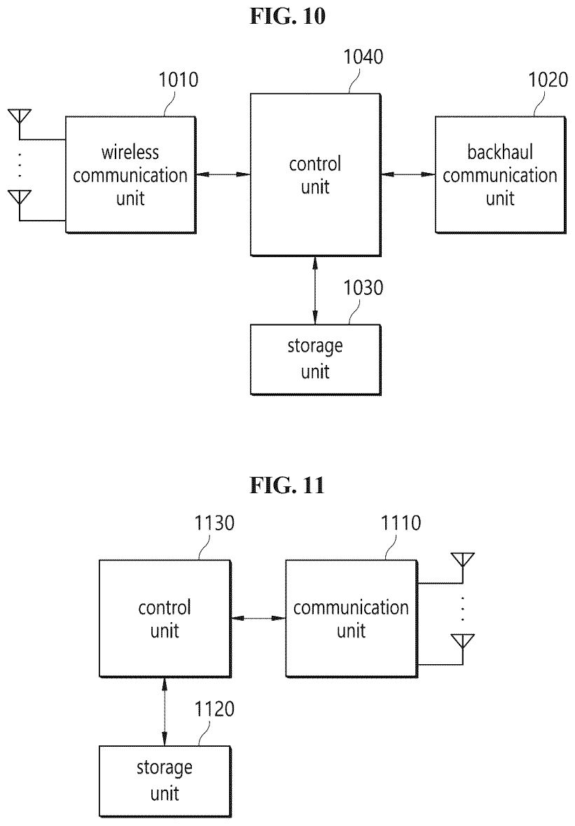

FIG. 10 is a view illustrating a configuration diagram of a base station in a wireless communication system according to various exemplary embodiments of the present disclosure. The configuration illustrated in FIG. 10 may be understood as a configuration of a base station. Hereinafter, the terms used below, such as “˜part” and “˜group” mean a unit for processing at least one function or operation, and may be implemented by a combination of hardware and/or software.

Referring to FIG. 10, the base station may include a wireless communication unit 1010, a backhaul communication unit 1020, a storage unit 1030, and a control unit 1040.

The wireless communication unit 1010 may transmit and receive wireless signals through a wireless channel. For example, the wireless communication unit 1010 may perform a conversion function between a baseband signal and a bit stream according to the physical layer standards of a system. In addition, when transmitting data, the wireless communication unit 1010 may generate complex symbols by encoding and modulating a transmission bit stream. When receiving data, the communication unit 1110 may restore a reception bit stream by demodulating and decoding the baseband signal.

The wireless communication unit 1010 may upconvert a baseband signal into a radio frequency (RF) band signal and then transmit the RF band signal through an antenna, and may downconvert an RF band signal received through the antenna into a baseband signal. To this end, the wireless communication unit 1010 may include a transmission filter, a reception filter, an amplifier, a mixer, an oscillator, a digital to analog converter (DAC), an analog to digital converter (ADC), and the like.

The wireless communication unit 1010 may include a plurality of transmission and reception paths, and the wireless communication unit 1010 may include at least one antenna array composed of a plurality of antenna elements.

In terms of hardware, the wireless communication unit 1010 may include a digital unit and an analog unit, and the analog unit may include a plurality of sub-units according to operation power, operation frequencies, etc. The digital unit may be implemented with at least one processor (e.g., a digital signal processor (DSP)).

The wireless communication unit 1010 may transmit and receive wireless signals as described above. Accordingly, all or part of the wireless communication unit 1010 may be referred to as a “transmitter”, a “receiver”, or a “transceiver”. In addition, in the following description, transmission and reception, which are performed through a wireless channel, may include the above-described processing performed by the wireless communication unit 1010.

The backhaul communication unit 1020 may provide interfaces for communicating with other nodes in a network. That is, the backhaul communication unit 1020 may convert a bit stream transmitted from the base station to another node, for example, another access node, another base station, an upper node, a core network, etc., into a physical signal, and convert the physical signal received from another node into the bit stream.

The storage unit 420 may store data such as fundamental programs, applications, and setting information for the operations of the base station. The storage unit 1030 may be comprised of a volatile memory, a non-volatile memory, or a combination of the volatile memory and non-volatile memory. In addition, the storage unit 1030 may provide stored data according to a request of the control unit 1040.

The control unit 1040 may control the overall operations of the base station. For example, the control unit 1040 may transmit and receive signals through the wireless communication unit 1010 or the backhaul communication unit 1020. In addition, the control unit 1040 may write and read data to and from the storage unit 1030. In addition, the control unit 1040 may perform protocol stack functions required by communication standards.

The control unit 1040 may include a first UE reconfiguration unit and a second UE reconfiguration unit. The first UE reconfiguration unit may transmit a connection reconfiguration request message to the UE. That is, by transmitting the connection reconfiguration request message composed at a base station to the UE, the UE may be induced to be able to apply new settings. For example, the transmission settings of the UE may be updated by including information on physical uplink control channel and uplink data channel reconfiguration.

The second UE configuration unit may perform the role of finally completing the reconfiguration of the UE on the basis of a connection reconfiguration complete message received from the UE. That is, after receiving the reconfiguration completion message from the UE, the base station may finally confirm and complete the reconfiguration process of the UE according to this message. For example, the settings of the UE may be matched to that of the base station through operations such as DRX setup and release, measurement gap setup and release, and secondary carrier reconfiguration.

To this end, the control unit 1040 may include at least one processor.

According to various exemplary embodiments of the present disclosure, the control unit 1040 may control the base stations of FIGS. 1A to 9 to perform operations according to the various exemplary embodiments.

FIG. 11 is a view illustrating a configuration diagram of a UE in the wireless communication system according to various exemplary embodiments of the present disclosure. The configuration illustrated in FIG. 11 may be understood as the configuration of the UE. Hereinafter, the terms used below, such as “˜part” and “˜group” mean a unit for processing at least one function or operation, and may be implemented by a combination of hardware and/or software.

Referring to FIG. 11, the UE may include a communication unit 1110, a storage unit 1120, and a control unit 1130.

The communication unit 1110 may perform functions for transmitting and receiving signals through a wireless channel. For example, the communication unit 1110 may perform a conversion function between a baseband signal and a bit stream according to the physical layer standards of a system. For example, when transmitting data, the communication unit 1110 may generate complex symbols by encoding and modulating a transmission bit stream. When receiving data, the communication unit 1110 may restore a reception bit stream by demodulating and decoding the baseband signal. In addition, the communication unit 1110 may upconvert a baseband signal into an RF band signal and then transmit the RF band signal through an antenna, and downconvert the RF band signal received through the antenna into the baseband signal. For example, the communication unit 1110 may include a transmission filter, a reception filter, an amplifier, a mixer, an oscillator, a DAC, an ADC, etc.

In addition, the communication unit 1110 may include a plurality of transmission and reception paths. Furthermore, the communication unit 1110 may include at least one antenna array composed of a plurality of antenna elements. In terms of hardware, the communication unit 1110 may include a digital circuit and an analog circuit (e.g., a radio frequency integrated circuit, RFIC). Here, the digital circuit and the analog circuit may be implemented in one package. In addition, the communication unit 1110 may include a plurality of RF chains. Furthermore, the communication unit 1110 may perform beamforming.

The communication unit 1110 transmits and receives signals as described above. Accordingly, all or part of the communication unit 310 may be referred to as a “transmitter”, a “receiver”, or a “transceiver”. In addition, in the following description, transmission and reception, which are performed through a wireless channel, may be used to mean that the above-described processing is performed by the communication unit 1110.

The storage unit 1120 may store data such as fundamental programs, applications, and setting information for the operations of a UE. The storage unit 1120 may be comprised of a volatile memory, a non-volatile memory, or a combination of the volatile memory and non-volatile memory. In addition, the storage unit 1120 may provide stored data according to a request of the control unit 1130.

The control unit 1130 may control the overall operations of the UE. For example, the control unit 1130 may transmit and receive signals through the communication unit 1110. In addition, the control unit 1130 may write and read data to and from the storage unit 1120. The control unit 1130 may perform protocol stack functions required by communication standards. To this end, the control unit 1130 may include at least one processor or microprocessor, or may be a part of the processor. In addition, a part of the communication unit 1110 and the control unit 1130 may be referred to as a communication processor (CP).

The control unit 1130 may include a reconfiguration unit. The reconfiguration unit performs the role of reconfiguring the settings of the UE according to a connection reconfiguration request message received from a base station. That is, when receiving the connection reconfiguration request message from the base station, the UE may update its own settings on the basis of the reconfiguration information included in this message. For example, reconfiguration of a physical uplink control channel and a physical uplink data channel of the UE may be performed, or operations such as DRX setup and release, measurement gap setup and release, and secondary carrier reconfiguration may be performed.

According to various exemplary embodiments, the control unit 1130 may control the UEs of FIGS. 1A to 9 to perform operations according to the various exemplary embodiments.

The methods according to the exemplary embodiments described in the claims or specification of the present disclosure may be implemented in the form of hardware, software, or a combination of hardware and software.

When implemented in software, a computer readable storage medium for storing one or more programs (i.e., software modules) may be provided. One or more programs stored in the computer-readable storage medium are configured for execution by one or more processors in an electronic apparatus. One or more programs include instructions that cause the electronic apparatus to execute the methods according to the exemplary embodiments described in the claims or specification of the present disclosure.

Such programs (i.e., software modules, software) may be stored in a random access memory, a non-volatile memory including a flash memory, a read only memory (ROM), an electrically erasable programmable read only memory (EEPROM), a magnetic disc storage device, a compact disc-ROM (CD-ROM), a digital versatile disc (DVD) or other forms of optical storage devices, or a magnetic cassette. Alternatively, such programs may be stored in a memory composed of a combination of some or all thereof. In addition, a plurality of configuration memories may also be included.

In addition, the programs may be stored in an attachable storage device that may be accessed through a communication network such as the Internet, an intranet, a local area network (LAN), a wide area network (WAN), or a storage area network (SAN), or through a communication network composed of a combination thereof. Such a storage device may be connected to a device for performing the exemplary embodiments of the present disclosure through an external port. In addition, a separate storage device on a communication network may be connected to a device for performing the exemplary embodiments of the present disclosure.

In the specific exemplary embodiments of the present disclosure described above, the components included in the disclosure are expressed in singular or plural numbers according to the specific exemplary embodiments presented. However, the singular or plural expressions are selected appropriately for the presented situation for convenience of description, and the present disclosure is not limited to the singular or plural components. Even components expressed in plural may be composed of a single component, or even a component expressed in a singular number may be composed of a plurality of components.

Meanwhile, in the detailed description of the present disclosure, specific exemplary embodiments have been described, but various modifications may be made without departing from the scope of the present disclosure. Therefore, the scope of the present disclosure should not be limited to the exemplary embodiments described above, but should be defined not only by the scope of claims described later, but also by those equivalent to the scope of these claims.

What is claimed is:

1. A method of operating a base station (BS) in a wireless communication system, the method comprising:
transmitting a connection reconfiguration request (RRCReconfiguration) message to a user equipment (UE);
reconfiguring the UE on the basis of the connection reconfiguration request message; and
completing the reconfiguration of the UE on the basis of a connection reconfiguration complete (RRCReconfigurationComplete) message received from the UE.

2. The method of claim 1, wherein the process of reconfiguring of the UE comprises:
reconfiguring a physical uplink control channel and a physical uplink data channel of the UE.

3. The method of claim 1, wherein the completing of the reconfiguration of the UE comprises:
reconfiguring a physical downlink data channel on the basis of the connection reconfiguration request message after the connection reconfiguration complete message is received.

4. The method of claim 3, wherein the completing of the reconfiguration of the UE comprises:
performing setup and release of discontinuous reception (DRX).

5. The method of claim 3, wherein the completing of the reconfiguration of the UE comprises:
performing setup and release of a measurement gap (measGapConfig).

6. The method of claim 3, wherein the completing of the reconfiguration of the UE comprises:
performing an additional carrier list (sCellToAddModList) and a release carrier list (sCellToReleaseList).

7. A base station (BS) in a wireless communication system, the BS comprising:
a transceiver,
a first user equipment (UE) reconfiguration unit;
a second user equipment (UE) reconfiguration unit; and
a control unit operably connected to the transceiver, the first UE reconfiguration unit, and the second UE reconfiguration unit,
wherein the control unit is configured to transmit a connection reconfiguration request (RRCReconfiguration) message to the user equipment (UE), reconfigure the UE on the basis of the connection reconfiguration request message, and complete the reconfiguration of the UE on the basis of a connection reconfiguration complete (RRCReconfigurationComplete) message received from the UE.

8. The BS of claim 7, wherein, in order to reconfigure the UE, the control unit reconfigures a physical uplink control channel and a physical uplink data channel of the UE.

9. The BS of claim 7, wherein, in order to complete the reconfiguration of the UE, the control unit reconfigures a physical downlink data channel on the basis of the connection reconfiguration request message after the connection reconfiguration complete message is received.

10. The BS of claim 9, wherein, in order to complete the reconfiguration of the UE, the control unit performs setup and release of discontinuous reception (DRX).

11. The BS of claim 9, wherein, in order to complete the reconfiguration of the UE, the control unit performs setup and release of a measurement gap (measGapConfig).

12. The BS of claim 9, wherein, in order to complete the reconfiguration of the UE, the control unit performs an additional carrier list (sCellToAddModList) and a release carrier list (sCellToReleaseList).

13. A method of operating a UE in a wireless communication system, the method comprising:
receiving a connection reconfiguration request (RRCReconfiguration) message from a base station;
reconfiguring the UE on the basis of the connection reconfiguration request message; and
transmitting a connection reconfiguration complete (RRCReconfigurationComplete) message to the base station after the connection reconfiguration is completed.

14. The method of claim 13, wherein the process of reconfiguring the UE comprises:
reconfiguring a physical uplink control channel and a physical uplink data channel of the UE.

15. The method of claim 13, wherein the process of reconfiguring the UE comprises:
reconfiguring a physical downlink data channel on the basis of the connection reconfiguration request message after the connection reconfiguration complete message is received.

16. The method of claim 15, wherein the process of reconfiguring the UE comprises:
performing setup and release of discontinuous reception (DRX).

17. The method of claim 15, wherein the process of reconfiguring the UE comprises:
performing setup and release of a measurement gap (measGapConfig).

18. The method of claim 15, wherein the process of reconfiguring the UE comprises:
performing an additional carrier list (sCellToAddModList) and a release carrier list (sCellToReleaseList).
